(19) United States
(12) Patent Application Publication
(10) Pub. No.: US 2012/0298766 A1
(43) Pub. Date: Nov. 29, 2012

(54) Fuel Injector Tip Seal And Method Of Assembly

(75) Inventors: Raymond L. Szparagowski, Bowling Green, OH (US); Pete T. Weising, Jenera, OH (US)

(73) Assignee: FREUDENBERG-NOK GENERAL PARTNERSHIP, Plymouth, MI (US)

(21) Appl. No.: 13/114,165

(22) Filed: May 24, 2011

(51) Int. Cl. B05B 1/30; B21D 51/16

(52) U.S. Cl. 239/1; 29/890.09; 239/584

(57) ABSTRACT

A method of installing a seal on a fuel injector includes installing a seal in a groove in an outer surface of the fuel injector. The seal is then clamped in a heated clamp portion at a temperature sufficient to soften a material of the seal to allow the material to flow into the seal groove. The seal is then cooled while being maintained in the clamped state to allow the heated material to set to a desired outer diameter size. The seal groove in the fuel injector may be provided with an extrusion zone into which the softened material of the seal is allowed to flow as the seal outer diameter is reduced to the desired diameter during the heating and clamping process.

### FIELD

The present disclosure relates to seals for fuel injector tips, and more particularly, a method of assembly for a fuel injector tip seal.

### BACKGROUND

This section provides background information related to the present disclosure which is not necessarily prior art.

Fuel injectors are commonly used for internal combustion engines for directly injecting fuel into a cylinder of the engine. The fuel injector generally includes a tip having an opening through which the fuel is injected into the cylinder. The fuel injectors are typically provided with a seal that extends around the tip where the fuel injector enters into the cylinder.

The tip seals have concerns when assembled into the bore. The seal can move away from the groove wall on the combustion side due to the forces required to insert the seal. This allows more room for combustion gases, and increases the seal exposure to higher temperatures, and may result in failed seals. The insertion force is due to several factors, including the requirement to size the seal into the groove during installation into the bore, the seal/groove dimensional tolerance stackups, and the groove design in the exterior surface of the fuel injector. Accordingly, it is desirable to provide a fuel injector tip seal that is more precisely sized on its outer diameter so as to more precisely fit into the bore during installation.

### SUMMARY

This section provides a general summary of the disclosure, and is not a comprehensive disclosure of its full scope or all of its features.

The present disclosure provides a method of installing a seal on a fuel injector including installing a seal in a groove in an outer surface of the fuel injector. The seal is then clamped in a heated clamp portion at a temperature sufficient to soften a material of the seal to allow the material to flow into the seal groove. The seal is then cooled while being maintained in the clamped state to allow the heated material to set to a desired outer diameter size.

The seal groove in the fuel injector may be provided with an extrusion zone into which the softened material of the seal is allowed to flow as the seal outer diameter is reduced to the desired diameter during the heating and clamping process. The extrusion zone can take on many shapes, including a chamfered edge along the seal groove, a radiused edge along the seal groove, an undercut region along the side of the seal groove, or a plurality of recessed regions in the floor of the groove. The cooling of the seal in the clamped state can include providing a cold clamp portion spaced from the heated clamp portion wherein the seal is moved axially from the heated clamp portion to the cold clamp portion while maintaining the clamped force on the seal. The fuel injector can then be removed from the cold clamp portion while measuring a removal force and comparing the measured removal force to a predetermined force value associated with a desired seal configuration. The measured removal force can be evaluated to determine the quality of the forming of the seal portion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a clamping arrangement for forming the seal on the tip of a fuel injector, according to the principles of the present disclosure;

FIG. 2 is an exploded schematic view illustrating the heated clamp portion and cooled clamp portion for forming the seal on the tip of a fuel injector according to the principles of the present disclosure;

FIG. 3 illustrates a fuel injector tip having a groove having a chamfered edge that provides an extrusion zone according to the principles of the present disclosure;

FIG. 4 is a cross-sectional view of a groove in a fuel injector provided with a radiused edge portion that serves as an extrusion zone according to the principles of the present disclosure;

FIG. 5 is a cross-sectional view of a groove in a fuel injector that includes an undercut portion in a sidewall thereof that serves as an extrusion zone according to the principles of the present disclosure; and

FIG. 6 is a cross-sectional view of a groove in a fuel injector having a plurality of recessed regions in the floor of the groove that serve as extrusion zones according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

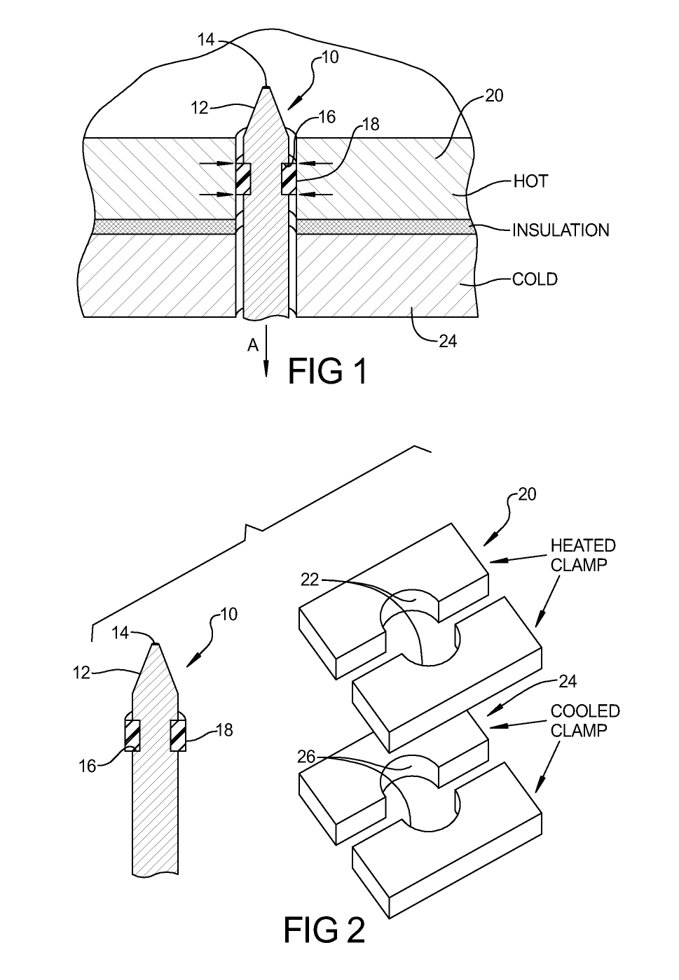

With reference to FIGS. 1 and 2, a fuel injector 10 is shown including an injector tip 12 having an aperture 14 through which fuel can pass. The fuel injector 10 includes a groove 16 in an outer surface thereof. The groove 16 can include forward and rearward sidewalls and a floor extending therebetween. An annular seal 18 is received in the groove 16.

According to the installation method, the fuel injector 10 with the seal 18 installed therein is then inserted into a heated clamp portion 20. The heated clamp portion 20 includes aperture portions 22 which, when closed together, define an aperture having an inner diameter that is sized to a desired diameter of the seal 18. The heated clamp 20 is also heated to a desired temperature sufficient to soften the material of the seal 18 to allow the seal material to flow into the seal groove 16 and reduce the seal's diameter to the desired seal diameter. It is noted that for a seal material such as PTFE (Polytetrafluoroethylene), a temperature of greater than 250° C. may be required in order to sufficiently soften the material to allow the material to flow to its desired outer diameter size. A cooled clamp portion 24 can also be provided for cooling the seal material in order to allow the seal material to set into its sized position. It is noted that the cooled clamp portion 24 includes similarly arranged aperture portions 26 that, when brought together, define an aperture size having an inner diameter equal to the desired outer diameter size of the seal 18. It is anticipated that, as shown in FIG. 1, the injector 12 can be initially positioned relative to the heated clamp portion 20 so that the seal 18 is received therein and can be heated and formed to its desired shape and size. The injector 12 can then be withdrawn in the direction of Arrow A so that the seal 18 is then received in the cooled clamp portion 24 in order to set the material of the seal 18 in its desired size. The clamp 20, 24 can then be opened for receipt of a subsequent fuel injector and seal assembly. It should be noted that although the heated and cooled clamp portions 20, 24 are shown as a two-component clamp, other arrangements of multiple clamp components using three or more clamp portions could also be utilized. It is further noted that an insulation layer can be provided between the heated clamp portions 20 and cooled clamp portions 24 in order to provide a separation between the two clamp zones so that proper heating is obtained in the heated clamp portion, and proper cooling is obtained in the cooled clamp portion. The insulation layer 28 can be of a necessary thickness to provide the appropriate insulation for achieving this outcome.

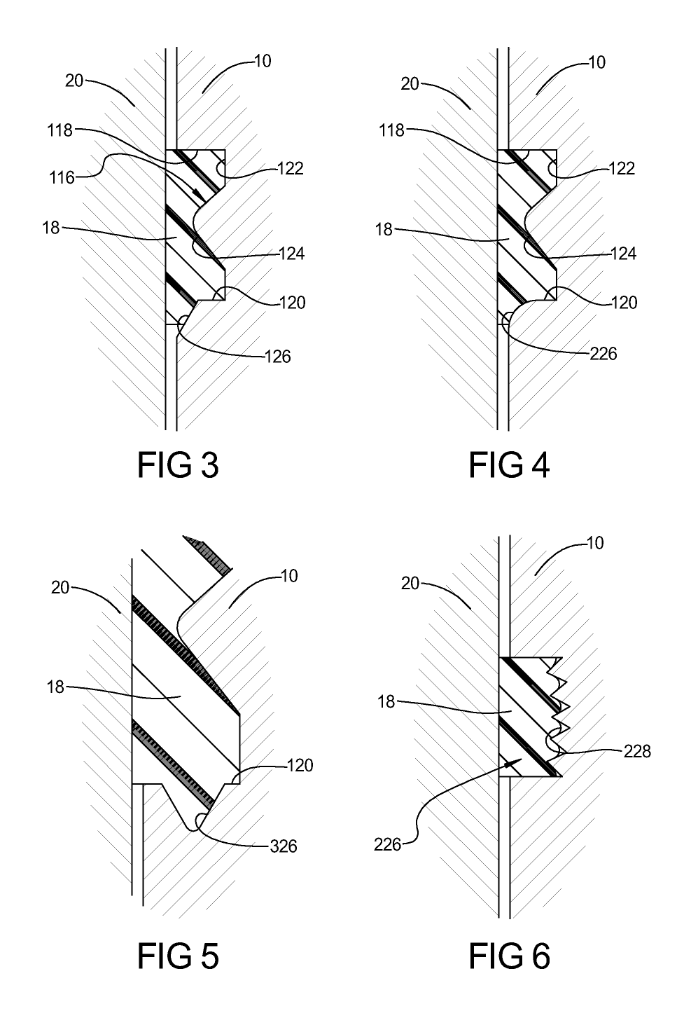

With reference to FIG. 3, a fuel injector 10 is shown provided with a groove 116 for receiving a seal 18 wherein the groove 116 includes a first sidewall 118 and a second sidewall 120, and a floor 122 extending therebetween. The floor 122 can be provided with a raised rib 124 and the sidewall 120 can be provided with a chamfered edge 126 that serves as an extrusion zone for receiving the flow of softened material of the seal 18 when seal 18 is heated and compressed by the heated clamp portion 20. It is noted that initially, the seal 18 has a width that is approximately equal to, or less than, the distance between the sidewalls 118, 120 of the groove 116. Upon the heating and deforming of the seal material 18, the seal material becomes softened and flows into the extrusion zone 126 to relieve compression forces in the material 18 so that when the material seal 18 is cooled, it becomes set at the predetermined outer diameter as defined by the inner diameter of the aperture in the clamp portions 20, 24.

With reference to FIG. 4, it is noted that the extrusion zone can be formed by a radiused edge 226 that is similar to the chamfered edge 126, as described with reference to FIG. 3. It is noted that the remaining concept of the extrusion zone created by the radiused edge 226 is otherwise similar to that described with reference to FIG. 3 so that no further description is provided herein.

As yet another alternative arrangement, as illustrated in FIG. 5, the sidewall 120 of the groove 116 can be provided with an undercut region 326 that serves as an extrusion zone for softened material of the seal 18 to flow into during the heating and clamping process. It is noted that in each of the embodiments shown in FIGS. 3-5, the protruding rib 124 provided in the floor of the groove 116 allows the softened material of the seal 18 to flow there around in order to further lock the seal material 18 within the groove 116 in order to inhibit axial shifting of the seal 18 due to axial forces when being installed in a bore.

As still another alternative arrangement, FIG. 6 illustrates the groove 226 in the injector 10 having a floor 228 that includes a plurality of recesses therein that serve as extrusion zones for receiving the flow of material from the seal 18 as the seal is softened and clamped to its desired dimension. It should be understood that the number of recesses 230, as well as the size and shape of the recesses can be particularly selected in order to accommodate the amount of flow necessary to achieve the desired final size of the seal 18.

It is noted that with the embodiments of FIGS. 3 and 4, the amount of material that extrudes into the extrusion zones 126, 226 can be visually measured and/or monitored in order to verify that the amount of fill into the extrusion zone is either too high or too low.

It is further noted that while removing the fuel injector from the cooled clamped portion 24, the removal force can be measured and compared to a predetermined force value associated with a desired seal configuration. If the measured removal force is not within a predetermined range, it may be determined that the seal 18 was improperly formed and may need either further inspection and/or may be considered unsuitable for use. Accordingly, the system of the present disclosure provides alternative approaches to verify the groove fill for undersized and oversized conditions. An oversized seal can create high assembly forces which are undesirable. Furthermore, an undersized seal provides the risk of leakage or burnt seals. Seals with either too large or too small of a diameter can now be verified by measuring the force to remove the seal from the sizing operation and/or by checking the extrusion zone fill amount. The improved method therefore provides for detection of proper seal-to-groove fill and prevents a defective seal from being sent to a customer.

The use of the extrusion zones as discussed above can control the force of insertion by taking up variations in components to allow better outer diameter force distribution and control. The extrusion zone will reduce stresses in the seal from thermal expansion as it creates a place for material to go when heated and compressed. The extrusion zones also allow for larger dimensional tolerances in both the seal 18 and groove dimensions without risk to performance.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of installing a seal on a fuel injector, comprising:
assembling a seal in a seal groove in an outer surface of the fuel injector;
clamping the seal in a heated clamp portion at a temperature sufficient to soften a material of the seal to allow the material to flow into the seal groove; and
cooling the seal in the clamped state to allow the heated material to set to a desired outer diameter size.

2. The method according to claim 1, wherein said seal groove in the fuel injector includes an extrusion zone into which the softened material of the seal is allowed to flow.

3. The method according to claim 2, wherein said extrusion zone includes a chamfered edge along said seal groove.

4. The method according to claim 2, wherein said extrusion zone includes a radiused edge along said seal groove.

5. The method according to claim 2, wherein said extrusion zone includes an undercut region along a side of said seal groove.

6. The method according to claim 2, wherein seal groove includes a pair of side edges and a floor extending therebetween and said extrusion zone includes one or more recessed regions in the floor of said groove.

7. The method according to claim 6, wherein said floor includes a plurality of recessed regions.

8. The method according to claim 1, wherein said cooling of the seal in the clamped state includes providing a cooled clamp portion spaced from said heated clamp portion and axially moving the seal and said fuel injector relative to said heated clamp so that said seal is moved into said cooled clamp portion while maintaining the clamped force on the seal.

9. The method according to claim 8, further comprising removing the fuel injector from the cooled clamp portion while measuring a removal force and comparing the measured removal force to a predetermined force value associated with a desired seal configuration.

10. The method according to claim 8, further comprising providing an insulation layer between said heated clamp portion and said cooled clamp portion.

11. The method according to claim 2, further comprising measuring an amount of material fill into said extrusion zone.

12. A fuel injector, comprising:
an injector body having a fuel passage therein in communication with a tip of the injector body, a seal groove formed in an exterior surface of said injector body and including an extrusion zone extending from said seal groove; and
a seal received in said seal groove and heat set therein wherein a material of said seal is received in said extrusion zone.

13. The fuel injector according to claim 12, wherein said extrusion zone includes a chamfered edge along said seal groove.

14. The method according to claim 12, wherein said extrusion zone includes a radiused edge along said seal groove.

15. The method according to claim 12, wherein said extrusion zone includes an undercut region along a side of said seal groove.

16. The method according to claim 12, wherein said seal groove includes a pair of side edges and a floor extending therebetween and said extrusion zone includes one or more recessed regions in the floor of said groove.

17. The method according to claim 16, wherein said floor includes a plurality of recessed regions.
